(19) United States
(12) Patent Application Publication
(10) Pub. No.: US 2012/0250806 A1
(43) Pub. Date: Oct. 4, 2012

(54) NON-PARAMETRIC UPLINK INTERFERENCE CANCELLATION

(76) Inventors: Wei Zhang, San Diego, CA (US); Sharad Deepak Sambhwani, San Diego, CA (US)

(21) Appl. No.: 13/355,774

(22) Filed: Jan. 23, 2012

Related U.S. Application Data
(60) Provisional application No. 61/468,426, filed on Mar. 28, 2011.

(51) Int. Cl. H04B 1/10

(52) U.S. Cl. 375/343

(57) ABSTRACT

Aspects of an apparatus and method of wireless communication include detecting, by a base node, at least one path of a transmission corresponding to received samples from a user equipment. Further, the aspects include assigning a bank of correlators around the detected at least one path, and estimating a composite channel impulse response at an output of each correlator of the bank of correlators. Further, the aspects include refining noisy channel estimates, and reconstructing a received signal from the user equipment based on the refined noisy channel estimate of the composite channel impulse response. Additionally, the aspects include canceling the reconstructed received signal from the received samples

### CLAIM OF PRIORITY UNDER 35 U.S.C. §119

The present Application claims priority to Provisional Application No. 61/468,426, entitled “Non-Parametric Uplink Interference Cancellation,” filed Mar. 28, 2011, and assigned to the assignee hereof and hereby expressly incorporated by reference herein.

### BACKGROUND

Aspects of the present disclosure relate generally to wireless communication systems, and more particularly, to interference cancellation for multipath error in a digital transmission.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSDPA), which provides higher data transfer speeds and capacity to associated UMTS networks.

A rake receiver is a radio receiver designed to counter the effects of multipath fading. It does this by using several “sub-receivers” called fingers, that is, several correlators each assigned to a different multipath component. Each finger independently decodes a single multipath component; at a later stage the contribution of all fingers are combined in order to make the most use of the different transmission characteristics of each transmission path. This could very well result in higher signal-to-noise ratio, or the energy per bit to noise power spectral density ratio (E_{b}/N₀), in a multipath environment than in a “clean” environment. The multipath channel through which a radio wave transmits can be viewed as transmitting the original (line of sight) wave plus a number of multipath components. Multipath components are delayed copies of the original transmitted wave traveling through a different echo path, each with a different magnitude and time-of-arrival at the receiver. Since each component contains the original information, if the magnitude and time-of-arrival (phase) of each component is computed at the receiver (through a process called channel estimation), then all the components can be added coherently to improve the information reliability. The rake receiver is so named because it reminds the function of a garden rake, each finger collecting symbol energy similarly to how tines on a rake collect leaves. Rake receivers are common in a wide variety of CDMA and W-CDMA radio devices such as mobile phones and wireless LAN equipment.

A conventional uplink interference cancellation (UL IC) design is based on the Rake front-end demodulator. In an abstracted wireless channel model, a multipath channel is a certain number of paths separated by at least 1 chip with independent distributed amplitudes. The Rake receiver model assumes that these paths are independent and resolvable. However, a realistic channel is often characterized by clusters of arriving paths. The first arriving cluster is due to scattering and reflections off surfaces near the transmitter, receiver, or line of sight path between the transmitter and receiver. The additional received clusters are due to reflections off large surfaces such as buildings or mountains. If the time span of a given received cluster is large enough, or the time delay between any two clusters is small enough, the received signal cannot be modeled as independent resolvable paths. In such cases, the Rake receiver performance suffers from inaccurate parameter estimation and, more seriously, channel model mismatch. This may be fine for the purpose of demodulation but can be a bottle neck for interference cancellation (IC).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the present disclosure provides a method for wireless communication by detecting, by a base node, at least one path of a transmission corresponding to received samples from a user equipment, assigning a bank of correlators around the detected at least one path, estimating a composite channel impulse response at an output of each correlator of the bank of correlators, refining noisy channel estimates, reconstructing a received signal from the user equipment based on the refined noisy channel estimate of the composite channel impulse response, and canceling the reconstructed received signal from the received samples.

In another aspect, the present disclosure provides at least one processor for wireless communication. A first module detects at least one path of a transmission corresponding to received samples from a user equipment. A second module assigns a bank of correlators around the detected at least one path. A third module estimates a composite channel impulse response at an output of each correlator of the bank of correlators. A fourth module refines noisy channel estimates. A fifth module reconstructs a received signal from the user equipment based on the refined noisy channel estimate of the composite channel impulse response. A sixth module cancels the reconstructed received signal from the received samples.

In an additional aspect, the present disclosure provides a computer program product for wireless communication comprising a non-transitory computer-readable storage medium storing sets of code. A first set of code causes a computer to detect at least one path of a transmission corresponding to received samples from a user equipment. A second set of code causes the computer to assign a bank of correlators around the detected at least one path. A third set of code causes the computer to estimate a composite channel impulse response at an output of each correlator of the bank of correlators. A fourth set of code causes the computer to refine noisy channel estimates. A fifth set of code causes the computer to reconstruct a received signal from the user equipment based on the refined noisy channel estimate of the composite channel impulse response. A sixth set of code causes the computer to cancel the reconstructed received signal from the received samples.

In a further aspect, the present disclosure provides an apparatus for wireless communication. The apparatus comprises means for detecting at least one path of a transmission corresponding to received samples from a user equipment. The apparatus comprises means for assigning a bank of correlators around the detected at least one path. The apparatus comprises means for estimating a composite channel impulse response at an output of each correlator of the bank of correlators. The apparatus comprises means for refining noisy channel estimates. The apparatus comprises means for reconstructing a received signal from the user equipment based on the refined noisy channel estimate of the composite channel impulse response. The apparatus comprises means for canceling the reconstructed received signal from the received samples.

In yet another aspect, the present disclosure provides an apparatus, such as a base node, for wireless communication. A receiver detects at least one path of a transmission corresponding to received samples from a user equipment. A computing platform assigns a bank of correlators around the detected at least one path, estimates a composite channel impulse response at an output of each correlator of the bank of correlators, refines noisy channel estimates, reconstructs a received signal from the user equipment based on the refined noisy channel estimate of the composite channel impulse response, and cancels the reconstructed received signal from the received samples.

To the accomplishment of the foregoing and related ends, the one or more aspects comprise the features hereinafter described in detail and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic block diagram of a digital transmission chain;

FIG. 2 is a graphical depiction of a Rake-based channel reconstruction;

FIG. 3 is a schematic block diagram of a non-parametric interference cancellation (IC) receiver of a digital transmission chain according to one aspect;

FIG. 4 is a schematic block diagram of a correlator bank and channel estimation;

FIG. 5 is a diagram of user equipment and a base node for wireless communication, such as for uplink interference cancellation;

FIG. 6 is a flow diagram of a methodology for wireless communication, such as for uplink interference cancellation;

FIG. 7 is a diagram illustrating an example of a hardware implementation for an apparatus employing a processing system, such as for uplink interference cancellation;

FIG. 8 is a conceptual diagram illustrating an example of an access network including components for uplink interference cancellation;

FIG. 9 is a block diagram conceptually illustrating an example of a Node B, such as for uplink interference cancellation, in communication with a UE in a telecommunications system; and

FIG. 10 is a block diagram of a system of logical groups of electrical components for wireless communication, such as for uplink interference cancellation.

### DETAILED DESCRIPTION

A digital receiver incorporates non-parametric uplink interference cancellation to overcome multipath fading of a significantly large or small time difference between paths as to be unresolvable for a Rake front-end demodulator. A non-parametric Interference cancellation (IC) architecture is based on the estimation of the composite channel impulse response regardless of the physical path parameters (e.g., amplitude, phase, delay). The non-parametric IC system includes an IC front-end function, an IC back-end function, and a signal reconstruction function. In the front-end, the Rake front-end function is partially replaced by a correlator bank for chip-level processing to overcome the limitations previously identified. The IC back-end includes channel estimation and minimum mean square error (MMSE) scaling functions for each channel tap. The signal reconstruction function uses a different structure than parametric IC to reconstruct the signals.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

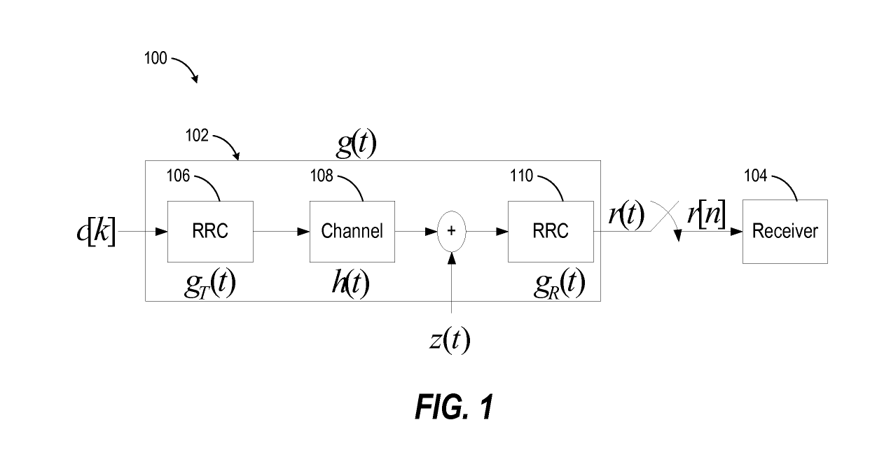

As an introduction to an IC system design with non-parametric channel model and its performance, in FIG. 1 an end-to-end chain 100 from a transmitter 102 to a receiver 104 is shown. At the transmitter 102, the chip sequence c[k] passes through the Root Raise Cosine (RRC) filter 106, the wireless channel h(t) 108, and the RRC filter 110. The receiver 104 filters the received signal and noise z(t) with a similar RRC filter. The output from the receiver filter is sampled for the subsequent digital processing.

The composite channel seen by the receiver is the convolution of transmitter filter, wireless channel, and receiver filter. It is given by:

g(t)=g_{T}(t)*h(t)*g_{R}(t) Eqn. 1

The received signal is

$$r ( t ) = {Σ}_{k} c [ k ] g ( t - {kT}_{c} ) + z ( t ) \qquad Eqn . 2$$

If the wireless channel has several physical paths with different delays, the channel response h(t) is given by:

$$h ( t ) = {Σ}_{l} {h}_{1} δ ( t - {τ}_{1} ) \qquad Eqn . 3$$

Then, the composite channel response is:

$$g ( t ) = {Σ}_{l} {h}_{l} {g}_{RC} ( t - {τ}_{1} ) \qquad Eqn . 4$$

where:

g_{RC}(t)=g_{T}(t)*g_{R}(t) Eqn. 5

The received signal can be written as:

$$r ( t ) = {Σ}_{k} c [ k ] {Σ}_{l} {h}_{l} {g}_{RC} ( t - {τ}_{1} - {kT}_{c} ) + z ( t ) \qquad Eqn . 6$$

In the case of parametric IC, the Rake receiver is chosen as the front-end. It tries to estimate the path gains hₗ and path delays τₗ. With known chip sequence c[k], the parametric IC will reconstruct the received signal with the estimated path gains ĥₗ and delays \hat{τ}ₗ. The reconstructed signal is given by:

$$\hat{s} ( t ) = {Σ}_{k} c [ k ] {Σ}_{l} {\hat{h}}_{l} {g}_{RC} ( t - {\hat{τ}}_{1} - {kT}_{c} ) \qquad Eqn . 7$$

However, the parametric IC method suffers from Rake receiver processing for multiple reasons. The Rake receiver could miss weak paths and never reconstruct them. And due to interference, errors are introduced in the delay estimates, which results in timing jitter for the fingers. More seriously, the Rake finger cannot be placed exactly at the true delays when the received signal cannot be modeled as independent resolvable paths (also referred to as fat path). The path gain estimates are inaccurate if the fingers are placed at wrong delays. Even in the ideal case where delay estimates are perfect, the path gain estimates are biased due to the composite channel response.

This can be explained with the following analysis. Assume that the Rake receiver wants to estimate m-th path gain hₘ, the Rake receiver first interpolates the samples at time t=nT_{c}+τₘ, given by:

$$r [ n ] = r ( t ) {\vert}_{t = {nT}_{c} + {τ}_{m}} = {Σ}_{k} c [ k ] {Σ}_{k} {h}_{j} {g}_{RC} ( {nT}_{c} + {τ}_{m} - {τ}_{l} - {kT}_{c} ) + z ( t ) \qquad Eqn . 8$$

Then it correlates the samples with the known chips (pilot). The correlator output is given by:

$$\begin{matrix}{\hat{h}}_{m} = \frac{1}{N} {\sum }_{n = 1}^{N} {c}^{*} [ n ] r [ n ] \\ = \frac{1}{N} {\sum }_{n = 1}^{N} {c}^{*} [ n ] c [ n ] {Σ}_{l} {h}_{l} {g}_{RC} ( {nT}_{c} + {τ}_{m} - {τ}_{l} - {nT}_{c} ) + \frac{1}{N} {\sum }_{n = 1}^{N} {c}^{*} [ n ] {Σ}_{k \neq n} c [ k ] {Σ}_{l} {h}_{l} {g}_{RC} ( {nT}_{c} + {τ}_{m} - {τ}_{l} - {nT}_{c} ) + {w}_{m} \\ = {Σ}_{l} {h}_{l} {g}_{RC} ( {τ}_{m} - {τ}_{l} ) \\ + \frac{1}{N} {\sum }_{n = 1}^{N} {c}^{*} [ n ] {Σ}_{k \neq n} c [ k ] {Σ}_{l} {h}_{l} {g}_{RC} ( {nT}_{c} + {τ}_{m} - {τ}_{l} - {nT}_{c} ) \\ + {w}_{m}\end{matrix} \qquad Eqn . 9$$

The correlator output is the rough channel estimate and will be refined by the following processing. It includes three terms. The first term is actually the composite channel response at time t=τₘ. The second term is due to inter-chip interference. The third term is due to the noise. The last two terms are both zero mean and can be suppressed by post processing. However, the mean of first term is not hₘ. Thus, the path gain estimate is inherently biased.

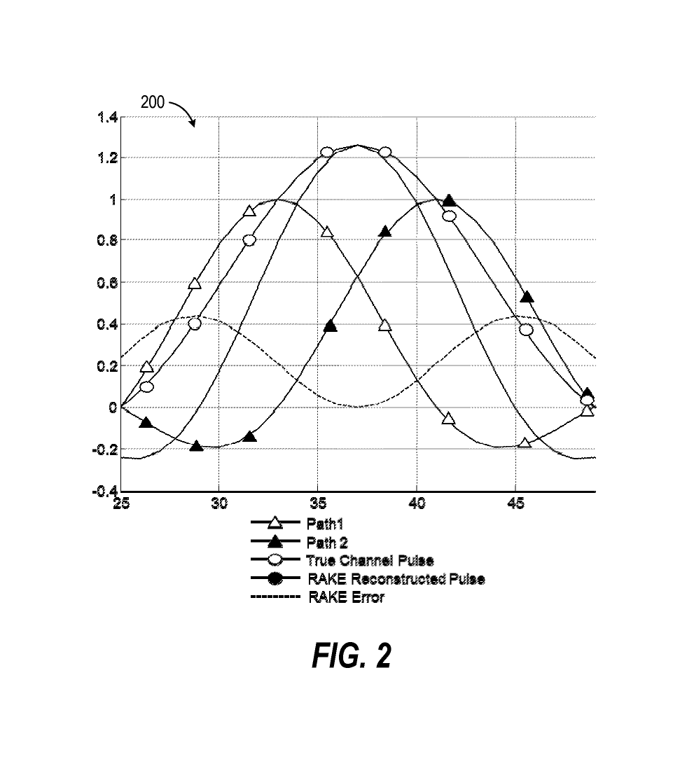

In FIG. 2, a graph 200 demonstrates the effect of composite channel response in the following example. Assume the channel has two physical paths (Path 1, Path 2), each having equal gain, but Path 2 has one chip delay relative to the Path 1. The true channel response is the linear supposition of the two pulses of Path 1 and Path 2. The Rake receiver treats the peak of the true channel response as one physical path. Thus, the Rake receiver places its finger at the delay where the peak of the true channel response is located to create a Rake reconstructed pulse. Thus, a large error exists between the true channel pulse and the Rake reconstructed pulse.

To overcome the problems related with parametric channel estimation, an alternate interference cancellation (IC) algorithm is disclosed that includes a non-parametric estimation of the channel impulse response (CIR) for the purpose of reconstruction and cancellation of the waveform.

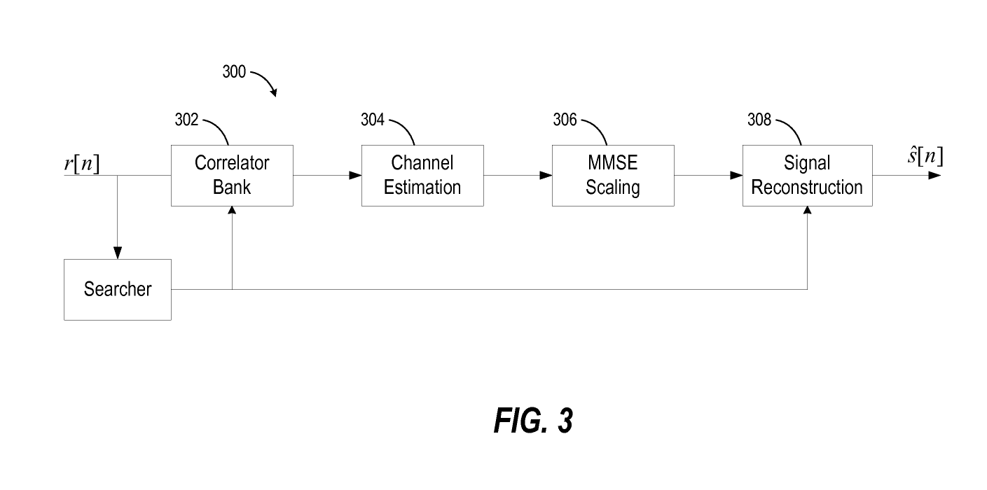

In FIG. 3, a non-parametric IC apparatus or system 300 is based on the estimation of the composite channel impulse response regardless of the physical path parameters (amplitude, phase, delay). The non-parametric IC system includes an IC front-end function, an IC back-end function, and a signal reconstruction function. In the front-end, the Rake front-end function is partially replaced by a correlator bank 302 for chip-level processing to overcome the limitations previously identified. The IC back-end includes a channel estimation function 304 and a minimum mean square error (MMSE) scaling function 306 for each channel tap. The signal reconstruction function 308 uses a different structure than parametric IC to reconstruct the signals.

The Rake front-end is maintained in the design as demodulator front-end. The input sample has chipx2 sampling rate. The correlators perform chip-level processing such as descrambling and despreading as a Rake finger. The correlators use the half-chip sampling timing of the sample buffer so that a timing interpolator is unneccessary. The correlation delays are in unit of ½ chip. This means the minimum offset between the delays of the correlators is ½ chip. In contrast, delays of Rake fingers are usually much farther away from each other to overcome the fat path effect. And Rake fingers need interpolator for finer resolution, usually up to 1/8 chip. The placement of the correlators can be searcher aided, in which correlators are only placed in clusters around Rake fingers. For example, correlators can be placed to cover the delay window [−2, +2]-chips around the Rake fingers. In another scheme, the placement of correlators can be window based. After identifying the first path, the described aspects may place consecutive correlators to cover a wide delay window starting from the first path. The input samples are denoted by:

$$r [ n ] = {Σ}_{k} c [ k ] g ( {nT}_{s} - {kT}_{c} ) + z [ n ] , {T}_{s} = {T}_{c} \text{/} 2 \qquad Eqn . 10$$

Assume there are K correlators with correlation delays d₀, d₁, . . . , d_{K-1}. The correlator outputs are:

$${\hat{g}}_{i} = \frac{1}{SF} {\sum }_{n = 1}^{N} {c}^{*} [ n ] r [ n + {d}_{i} ] , i = 0 , 1 , … K - 1 \qquad Eqn . 11$$

where SF is the spreading factor for the channel.

These soft symbols from correlator outputs are coarse channel estimates. To improve the channel estimation quality, channel estimation filter is used on the coarse channel estimates. The channel estimation filter is denoted as function ƒ( ). The refined channel estimates are given by:

\tilde{g}ᵢ=ƒ(ĝᵢ), i=0, 1, . . . , K−1 Eqn. 12

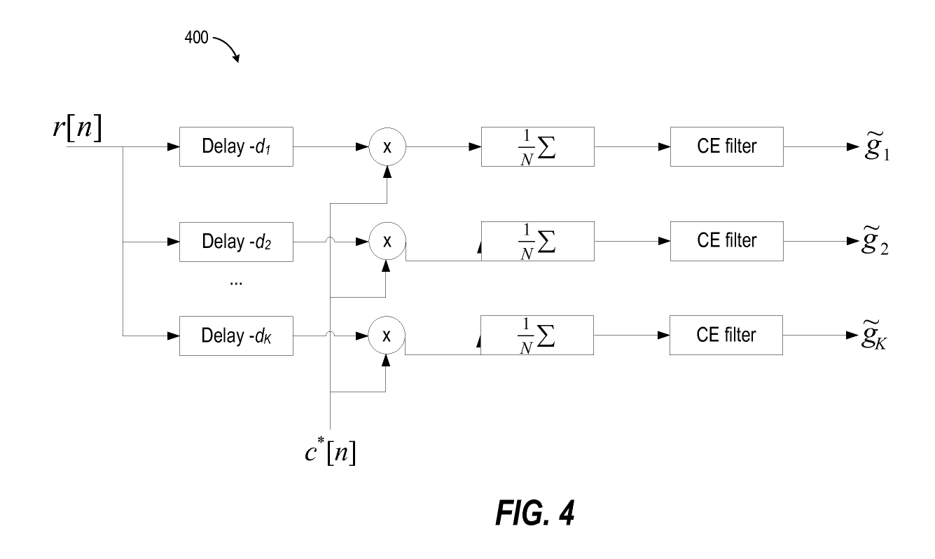

In essence, the channel response is modeled as a fractional chip spaced transversal filter with K taps. The composite channel response on the i-th tap is estimated as \tilde{g}ᵢ, i=0, 1, . . . , K. The correlator and channel estimation filter 400 are illustrated in FIG. 4.

The channel response on some taps may be very weak since it is generated by the side lobes of the physical paths. The channel estimates on the weak taps are usually noisy. Sometimes it is advantageous not reconstruct these weak taps at all. Therefore, in an aspect, several cleaning mechanisms are utilized to clean the channel estimates. An example mechanism is linear minimum mean square error (LMMSE) cleaning. The algorithm is described as below:

The signal power on each tap is calculated as:

\hat{p}ᵢ=|\tilde{g}ᵢ|², i=0, 1, . . . , K Eqn. 13

Filter F is used to filter the power on each tap, given as:

\tilde{p}ᵢ=F(\hat{p}ᵢ) Eqn. 14

For example, an Infinite Impulse Response (IIR) filter can be used for this purpose.

Estimate the noise power σᵢ² on each tap. A simple method to estimate the noise power is shown below:

Find the K smallest filtered tap powers.

Calculate the mean of these K values and use the mean as noise power.

Calculate a ratio between the filtered tap power and the noise power. The ratio is actually a signal to noise ratio on the tap

$${η}_{i} = \frac{{\tilde{p}}_{i}}{{σ}_{i}^{2}} \qquad Eqn . 15$$

Compare the ratio with a threshold:
If ηᵢ>Threshold, then keep this tap in the channel response estimate.
If ηᵢ<Threshold, then discard this tap from the channel response estimate.

The second cleaning method is MMSE scaling. The idea of MMSE scaling is to weigh the taps according to their SINR. The algorithm is described as below:

The signal power on each tap is calculated as:

\hat{p}ᵢ=|\tilde{g}ᵢ|², i=0, 1, . . . K−1 Eqn. 16

A filter F may be used to filter the power on each taps:

\tilde{p}ᵢ=F(\hat{p}ᵢ) Eqn. 17

For example, an IIR filter can be used for this purpose.

Estimate the noise power σᵢ² on each tap.

Compute the scaling factor as

$${α}_{i} = \frac{G \cdot {\tilde{p}}_{i}}{G \cdot {\tilde{p}}_{i} + {σ}_{i}^{2}} \qquad Eqn . 18$$

where G is the processing gain on channel estimation.

The scaled channel estimates are

g̅ᵢ=αᵢ\tilde{g}ᵢ Eqn. 19

Similar to the idea of linear minimum mean square estimate (LMMSE) cleaning, a threshold can be applied on the scale factor to eliminate the taps with a very small scale factor.

The signal is reconstructed based on the chipx2 channel response g̅ᵢ, i=0, 1, . . . , K−1. The reconstruction is accomplished by convolving the chip sequence with cleaned channel response. Since the channel response is two times the sampling rate of the chip sequence. The convolution can be done with a polyphase filter with even and odd phases. The even- and odd-phase filters are given by

g̅ᵢ^{(e)}= g̅₂ᵢ, i=0, 1, . . .

g̅ᵢ^{(o)}= g̅₂ᵢ₊₁, i=0, 1, . . . Eqn. 20

The even- and odd-phase samples are reconstructed by

\hat{s}^{(e)}[n]=c[n]* g̅ₙ^{(e)}

ŝ^{(o)}[n]=c[n]* g̅ₙ^{(o)} Eqn. 21

The even- and odd-phase samples are time multiplexed to the chipx2 reconstructed signal. The chipx2 reconstructed signal will be subtracted from the sample buffer to cancel the interference. Another method for signal reconstruction is to break the filtering processing to three steps:

upsample the chip sequence to chipx2 by inserting zeros, c[0], 0, c[1 ], 0, . . . ;

for the i-th tap, delay the upsampled chip sequence by dᵢ samples and multiply it with g̅ᵢ; and

then add these copies from all taps together.

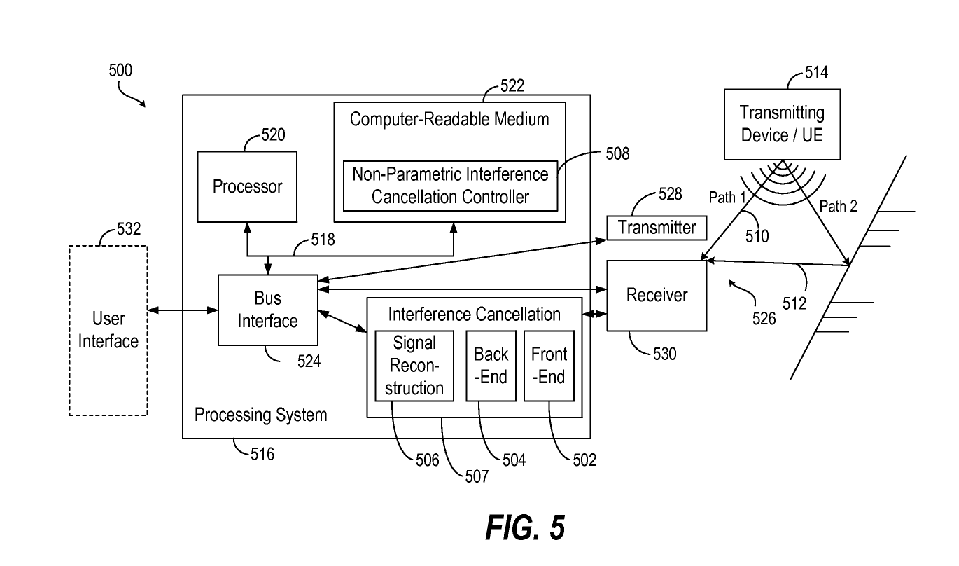

With reference to FIG. 5, the present disclosure provides an apparatus, which is depicted as base node 500, for wireless communication including an interference cancellation component 507 having a front-end component 502 with a correlator bank for chip-level processing, a back-end component 504 comprising a channel estimator and a minimum mean square error (MMSE) scaling functions for each channel tap, and a signal reconstructor 506. A controller 508 controls the interference cancellation component 507 by detecting at least one path 510, 512 of a transmission corresponding to received samples from a transmitting device 514, such as user equipment, assigning a bank of correlators around the detected at least one path, estimating a composite channel impulse response at an output of each correlator of the bank of correlators, refining noisy channel estimates, reconstructing a received signal from the user equipment based on the refined noisy channel estimate of the composite channel impulse response, and canceling the reconstructed received signal from the received samples.

For example, one implementation for the apparatus 500 (e.g., a base node) can employ a processing system 516. In this example, the processing system 516 may be implemented with a bus architecture, represented generally by the bus 518. The bus 518 may include any number of interconnecting buses and bridges depending on the specific application of the processing system 516 and the overall design constraints. The bus 518 links together various circuits including one or more processors, represented generally by a processor 520, and computer-readable media, represented generally by a computer-readable medium 522. The bus 518 may also link various other circuits such as timing sources, peripherals, voltage regulators, and power management circuits, which are well known in the art, and therefore, will not be described any further. A bus interface 524 provides an interface between the bus 518 and a transceiver 526 comprising a transmitter 528 and a receiver 530. The transceiver 526 provides a means for communicating with various other apparatus over a transmission medium. Depending upon the nature of the apparatus, a user interface 532 (e.g., keypad, display, speaker, microphone, joystick) may also be provided.

The processor 520 is responsible for managing the bus 518 and general processing, including the execution of software stored on the computer-readable medium 522. The software, when executed by the processor 520, causes the processing system 516 to perform the various functions described infra for any particular apparatus. The computer-readable medium 522 may also be used for storing data that is manipulated by the processor 520 when executing software.

In an exemplary aspect, the controller 508 for non-parametric interference cancellation can reside at least in part within the computer-readable medium 522.

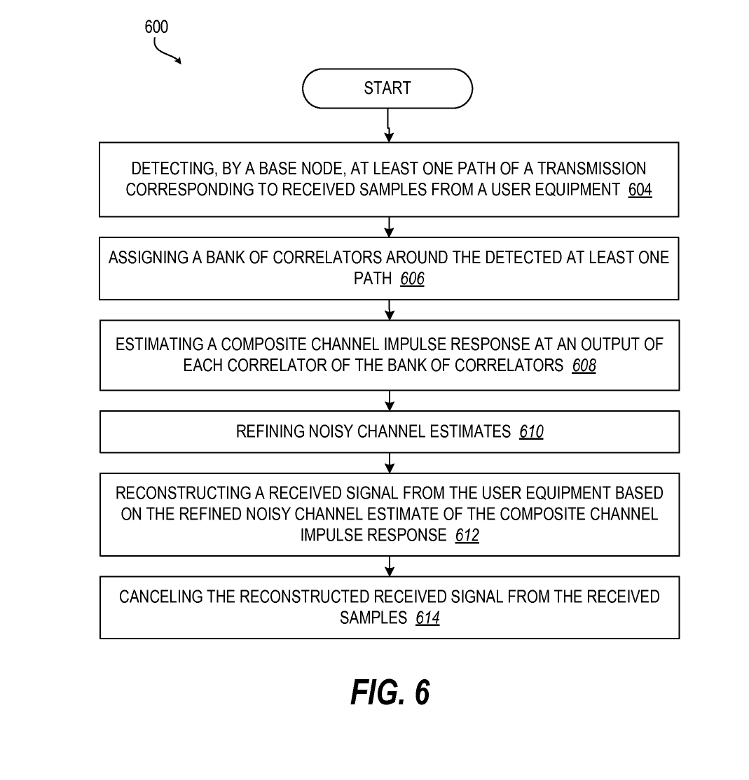

In FIG. 6, the present disclosure provides a methodology 600 for wireless communication, such as for uplink interference cancellation. The method provides detecting, by a base node, at least one path of a transmission corresponding to received samples from a user equipment (block 604), assigning a bank of correlators around the detected at least one path (block 606), estimating a composite channel impulse response at an output of each correlator of the bank of correlators (block 608), refining noisy channel estimates (block 610), reconstructing a received signal from the user equipment based on the refined noisy channel estimate of the composite channel impulse response (block 612), and canceling the reconstructed received signal from the received samples (block 614).

In one aspect, assigning correlator delays with sub-chip resolution to cover a delay window includes all of the detected paths.

In another aspect, correlator delays are assigned with sub-chip resolution to cover delay windows clustered around each of the detected paths.

In an additional aspect, each correlator output is filtered.

In a further aspect, refining the noisy channel estimate further comprises estimating signal power on each correlator output, estimating noise power on each correlator output, and deriving a scaling factor to be applied to each correlator output based on the estimated signal power and estimated noise power on each correlator output.

In yet another aspect, refining the noisy channel estimates further comprises estimating signal power on each correlator output, estimating noise power on each correlator output, and deriving a noise cleaning scaling factor to be applied on each correlator output based on the estimated signal power and estimated noise power on each correlator output. In an exemplary aspect, deriving the noise cleaning scaling factor on each correlator output further comprises estimating the signal to noise ratio at the correlator output. In another exemplary aspect, deriving the noise cleaning scaling factor on each correlator output is based on linear minimum mean square error criteria. In yet another exemplary aspect, a threshold is applied prior to applying a noise cleaning scaling factor at each correlator output.

In one aspect, reconstructing the received signal from the user equipment is by inputting the estimated and cleaned composite channel impulse response at half (½) chip resolution g̅ᵢ, i=0, 1, . . . , K−1, and convolving an uplink transmitted chip sequence with the channel estimate sequence g̅ᵢ using a polyphase filter structure.

In another aspect, reconstructing the received signal from the user equipment further comprises upsampling a first chip sequence to a second chip sequence that is twice as long by inserting zeros (c[0], 0, c[1], 0, . . . ), for an i-th tap of the estimated composite channel impulse response, wherein a delay=dᵢ, channel estimate= g̅ᵢ, delaying an upsampled chip sequence by dᵢ samples and multiplying a result with g̅ᵢ, and adding together copies from all taps.

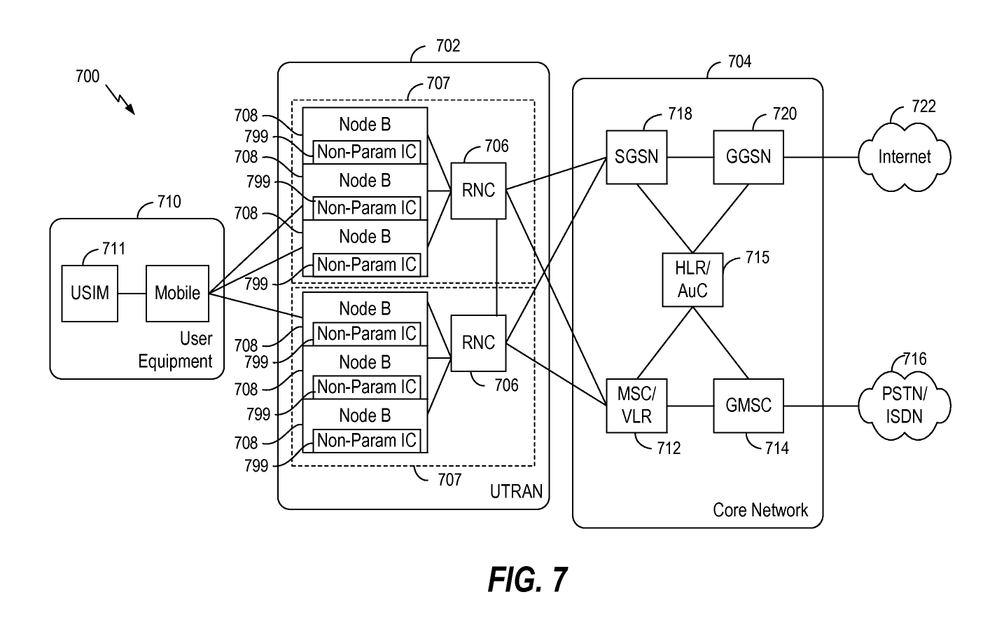

The various concepts presented throughout this disclosure may be implemented across a broad variety of telecommunication systems, network architectures, and communication standards. By way of example and without limitation, the aspects of the present disclosure illustrated in FIG. 7 are presented with reference to a UMTS system 700 employing a W-CDMA air interface. A UMTS network includes three interacting domains: a Core Network (CN) 704, a UMTS Terrestrial Radio Access Network (UTRAN) 702, and User Equipment (UE) 710. In this example, the UTRAN 702 provides various wireless services including telephony, video, data, messaging, broadcasts, and/or other services. The UTRAN 702 may include a plurality of Radio Network Subsystems (RNSs) such as an RNS 707, each controlled by a respective Radio Network Controller (RNC) such as an RNC 706. Here, the UTRAN 702 may include any number of RNCs 706 and RNSs 707 in addition to the RNCs 706 and RNSs 707 illustrated herein. The RNC 706 is an apparatus responsible for, among other things, assigning, reconfiguring and releasing radio resources within the RNS 707. The RNC 706 may be interconnected to other RNCs (not shown) in the UTRAN 702 through various types of interfaces such as a direct physical connection, a virtual network, or the like, using any suitable transport network.

Communication between a UE 710 and a Node B 708 may be considered as including a physical (PHY) layer and a medium access control (MAC) layer. Further, communication between a UE 710 and an RNC 706 by way of a respective Node B 708 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in Radio Resource Control (RRC) Protocol Specification, 3GPP TS 25.331 v9.1.0, incorporated herein by reference.

The geographic region covered by the RNS 707 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 708 are shown in each RNS 707; however, the RNSs 707 may include any number of wireless Node Bs. The Node Bs 708 provide wireless access points to a core network (CN) 704 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 710 may further include a universal subscriber identity module (USIM) 711, which contains a user's subscription information to a network. For illustrative purposes, one UE 710 is shown in communication with a number of the Node Bs 708. The downlink (DL), also called the forward link, refers to the communication link from a Node B 708 to a UE 710, and the uplink (UL), also called the reverse link, refers to the communication link from a UE 710 to a Node B 708.

The core network 704 interfaces with one or more access networks, such as the UTRAN 702. As shown, the core network 704 is a GSM core network. However, as those skilled in the art will recognize, the various concepts presented throughout this disclosure may be implemented in a RAN, or other suitable access network, to provide UEs with access to types of core networks other than GSM networks.

The core network 704 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 704 supports circuit-switched services with a MSC 712 and a GMSC 714. In some applications, the GMSC 714 may be referred to as a media gateway (MGW). One or more RNCs, such as the RNC 706, may be connected to the MSC 712. The MSC 712 is an apparatus that controls call setup, call routing, and UE mobility functions. The MSC 712 also includes a visitor location register (VLR) that contains subscriber-related information for the duration that a UE is in the coverage area of the MSC 712. The GMSC 714 provides a gateway through the MSC 712 for the UE to access a circuit-switched network 716. The GMSC 714 includes a home location register (HLR) 715 containing subscriber data, such as the data reflecting the details of the services to which a particular user has subscribed. The HLR is also associated with an authentication center (AuC) that contains subscriber-specific authentication data. When a call is received for a particular UE, the GMSC 714 queries the HLR 715 to determine the UE's location and forwards the call to the particular MSC serving that location.

The core network 704 also supports packet-data services with a serving GPRS support node (SGSN) 718 and a gateway GPRS support node (GGSN) 720. GPRS, which stands for General Packet Radio Service, is designed to provide packet-data services at speeds higher than those available with standard circuit-switched data services. The GGSN 720 provides a connection for the UTRAN 702 to a packet-based network 722. The packet-based network 722 may be the Internet, a private data network, or some other suitable packet-based network. The primary function of the GGSN 720 is to provide the UEs 710 with packet-based network connectivity. Data packets may be transferred between the GGSN 720 and the UEs 710 through the SGSN 718, which performs primarily the same functions in the packet-based domain as the MSC 712 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 708 and a UE 710. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

One or more of the Node Bs 708 can incorporate a non-parametric IC component 799 that can perform the methodology 600 and other aspects as described herein.

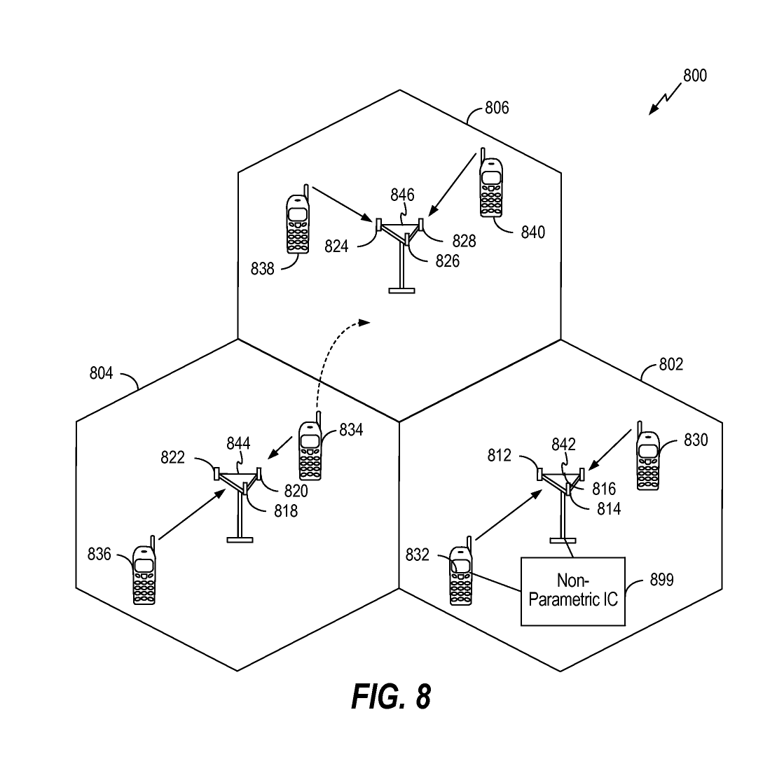

Referring to FIG. 8, an access network 800 in a UTRAN architecture is illustrated. The multiple access wireless communication system includes multiple cellular regions (cells), including cells 802, 804, and 806, each of which may include one or more sectors. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804 and 806 may include several wireless communication devices, e.g., User Equipment or UEs, which may be incommunication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a core network for all the UEs 830, 832, 834, 836, 838, 840 in the respective cells 802, 804, and 806.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 806, or at another suitable node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set).

The modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The Node B 842 or UE 832 can incorporate a non-parametric IC component 899 that can perform the methodology 600 and other aspects as described herein.

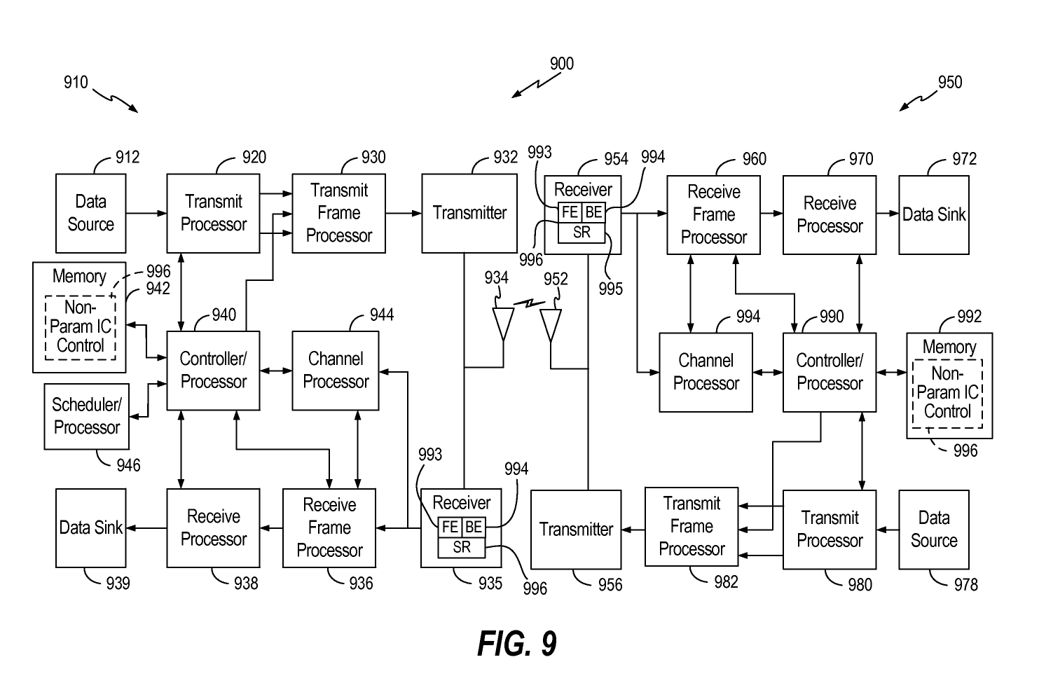

FIG. 9 is a block diagram of a Node B 910 in communication with a UE 950, where the Node B 910 may be the Node B 500 (FIG. 5), and the UE 950 may be the UE 514 (FIG. 5). In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the Node B 910. More specifically, the receive processor 970 descrambles and despreads the symbols, and then determines the most likely signal constellation points transmitted by the Node B 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receive processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

The receivers 935, 954 can utilize a non-parametric IC component, depicted as front-end (FE) 993, back-end (BE) 994, and Signal Reconstruction (SR) 995 that are under the control of a non-parametric IC controller 996, which in one alternative aspect may be resident respectively in memories 942, 992.

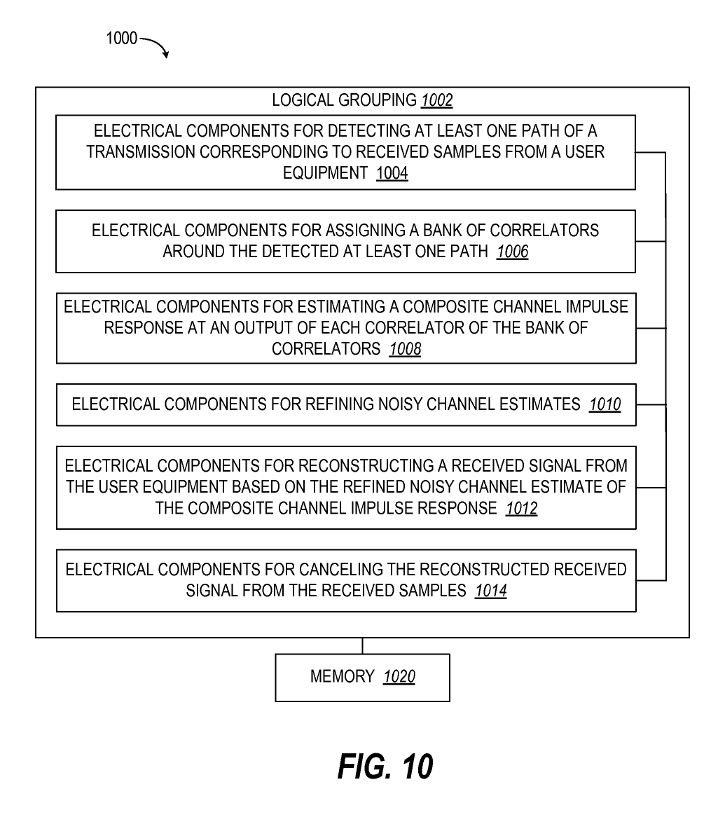

With reference to FIG. 10, illustrated is a system 1000 for wireless communication, such as for uplink interference cancellation. For example, system 1000 can reside at least partially within one or more network entities. The system 1000 can comprise a base node that is capable of Over-The-Air (OTA) communication. Aspects disclosed herein can further be distributed in a network entity for scheduling such as an RNC. It is to be appreciated that system 1000 is represented as including functional blocks, which can be functional blocks that represent functions implemented by a computing platform, processor, software, or combination thereof (e.g., firmware). System 1000 includes a logical grouping 1002 of electrical components that can act in conjunction. For instance, logical grouping 1002 can include an electrical component 1004 for detecting, by a base node, at least one path of a transmission corresponding to received samples from a user equipment. Moreover, logical grouping 1002 can include an electrical component 1006 for assigning a bank of correlators around the detected at least one path. Further, logical grouping 1002 can include an electrical component 1008 for estimating a composite channel impulse response at an output of each correlator of the bank of correlators. Further, logical grouping 1002 can include an electrical component 1010 for refining noisy channel estimates. In addition, logical grouping 1002 can include an electrical component 1012 for reconstructing a received signal from the user equipment based on the refined noisy channel estimate of the composite channel impulse response. Further, logical grouping 1002 can include an electrical component 1014 for canceling the reconstructed received signal from the received samples. Additionally, system 1000 can include a memory 1020 that retains instructions for executing functions associated with electrical components 1004-1014. While shown as being external to memory 1020, it is to be understood that one or more of electrical components 1004-1014 can exist within memory 1020.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
detecting, by a base node, at least one path of a transmission corresponding to received samples from a user equipment;
assigning a bank of correlators around the detected at least one path;
estimating a composite channel impulse response at an output of each correlator of the bank of correlators;
refining noisy channel estimates;
reconstructing a received signal from the user equipment based on the refined noisy channel estimate of the composite channel impulse response; and
canceling the reconstructed received signal from the received samples.

2. The method of claim 1, further comprising assigning correlator delays with sub-chip resolution to cover a delay window that includes all of the detected at least one path.

3. The method of claim 1, further comprising assigning correlator delays with sub-chip resolution to cover delay windows clustered around each of the detected at least one path.

4. The method of claim 1, further comprising filtering each correlator output.

5. The method of claim 1, wherein refining the noisy channel estimates further comprises:
estimating signal power on each correlator output;
estimating noise power on each correlator output; and
deriving a scaling factor to be applied to each correlator output based on the estimated signal power and estimated noise power on each correlator output.

6. The method of claim 1, wherein refining the noisy channel estimates further comprises:
estimating signal power on each correlator output;
estimating noise power on each correlator output; and
deriving a noise cleaning scaling factor to be applied on each correlator output based on the estimated signal power and estimated noise power on each correlator output.

7. The method of claim 6, wherein deriving the noise cleaning scaling factor on each correlator output further comprising estimating a signal to noise ratio at the correlator output.

8. The method of claim 6, further comprising deriving the noise cleaning scaling factor on each correlator output based on linear minimum mean square error criteria.

9. The method of claim 6, further comprising applying a threshold prior to applying a noise cleaning scaling factor at each correlator output.

10. The method of claim 1, wherein reconstructing the received signal from the user equipment comprises:
inputting an estimated and cleaned composite channel impulse response at half (½) chip resolution; and
convolving an uplink transmitted chip sequence with a channel estimate sequence g̅ᵢ using a polyphase filter structure.

11. The method of claim 1, wherein reconstructing the received signal from the user equipment further comprising:
upsampling a first chip sequence to a second chip sequence that is twice as long by inserting zeros (c[0], 0, c[1], 0, . . . );
for an i-th tap of the estimated composite channel impulse response, wherein a delay=dᵢ, a channel estimate sequence= g̅ᵢ, delaying an upsampled chip sequence by dᵢ samples and multiplying a result with g̅ᵢ; and
adding together copies from all taps.

12. At least one processor for wireless communication, comprising:
a first module for detecting at least one path of a transmission corresponding to received samples from a user equipment;
a second module for assigning a bank of correlators around the detected at least one path;
a third module for estimating a composite channel impulse response at an output of each correlator of the bank of correlators;
a fourth module for refining noisy channel estimates;
a fifth module for reconstructing a received signal from the user equipment based on the refined noisy channel estimate of the composite channel impulse response; and
a sixth module for canceling the reconstructed received signal from the received samples.

13. A computer program product for wireless communication, comprising:
a non-transitory computer-readable storage medium storing sets of code comprising:
a first set of code for causing a computer to detect at least one path of a transmission corresponding to received samples from a user equipment;
a second set of code for causing the computer to assign a bank of correlators around the detected at least one path;
a third set of code for causing the computer to estimate a composite channel impulse response at an output of each correlator of the bank of correlators;
a fourth set of code for causing the computer to refine noisy channel estimates;
a fifth set of code for causing the computer to reconstruct a received signal from the user equipment based on the refined noisy channel estimate of the composite channel impulse response; and
a sixth set of code for causing the computer to cancel the reconstructed received signal from the received samples.

14. An apparatus for wireless communication, comprising:
means for detecting at least one path of a transmission corresponding to received samples from a user equipment;
means for assigning a bank of correlators around the detected at least one path;
means for estimating a composite channel impulse response at an output of each correlator of the bank of correlators;
means for refining noisy channel estimates;
means for reconstructing a received signal from the user equipment based on the refined noisy channel estimate of the composite channel impulse response; and
means for canceling the reconstructed received signal from the received samples.

15. An apparatus for wireless communication, comprising:
a front-end component comprising a correlator bank for chip-level processing;
a back-end component comprising a channel estimator and a minimum mean square error (MMSE) scaling functions for each channel tap; and
a signal reconstructor;
a controller for controlling the front-end component, back-end component, and signal reconstructor by:
detecting at least one path of a transmission corresponding to received samples from a user equipment;
assigning a bank of correlators around the detected at least one path,
estimating a composite channel impulse response at an output of each correlator of the bank of correlators,
refining noisy channel estimates,
reconstructing a received signal from the user equipment based on the refined noisy channel estimate of the composite channel impulse response, and
canceling the reconstructed received signal from the received samples.

16. The apparatus of claim 15, wherein the controller is further for assigning correlator delays with sub-chip resolution to cover a delay window that includes all of the detected at least one path.

17. The apparatus of claim 15, wherein the controller is further for assigning correlator delays with sub-chip resolution to cover delay windows clustered around each of the detected at least one path.

18. The apparatus of claim 15, wherein the controller is further for filtering each correlator output.

19. The apparatus of claim 15, wherein the controller is further for refining the noisy channel estimates by:
estimating signal power on each correlator output;
estimating noise power on each correlator output; and
deriving a scaling factor to be applied to each correlator output based on the estimated signal power and estimated noise power on each correlator output.

20. The apparatus of claim 15, wherein the controller is further for refining the noisy channel estimates by:
estimating signal power on each correlator output;
estimating noise power on each correlator output; and
deriving a noise cleaning scaling factor to be applied on each correlator output based on the estimated signal power and estimated noise power on each correlator output.

21. The apparatus of claim 20, wherein the controller is further for deriving the noise cleaning scaling factor on each correlator output by estimating a signal to noise ratio at the correlator output.

22. The apparatus of claim 20, wherein the controller is further for deriving the noise cleaning scaling factor on each correlator output based on linear minimum mean square error criteria.

23. The apparatus of claim 20, wherein the controller is further for applying a threshold prior to applying a noise cleaning scaling factor at each correlator output.

24. The apparatus of claim 15, wherein the controller is further for reconstructing the received signal from the user equipment by:
inputting an estimated and cleaned composite channel impulse response at half (½) chip resolution; and
convolving an uplink transmitted chip sequence with a channel estimate sequence g̅ᵢ using a polyphase filter structure.

25. The apparatus of claim 15, wherein the controller is further for reconstructing the received signal from the user equipment by:
upsampling a first chip sequence to a second chip sequence that is twice as long by inserting zeros (c[0], 0, c[1], 0, . . . );
for an i-th tap of the estimated composite channel impulse response, wherein a delay=dᵢ, a channel estimate sequence= g̅ᵢ, delaying an upsampled chip sequence by dᵢ samples and multiplying a result with g̅ᵢ; and
adding together copies from all taps.
